(19) United States
(12) Patent Application Publication
(10) Pub. No.: US 2025/0363752 A1
(43) Pub. Date: Nov. 27, 2025

(54) EXPERIENCE SPACE SWITCHING METHOD, EXPERIENCE SPACE SWITCHING SYSTEM, EXPERIENCE SPACE SWITCHING APPARATUS, AND EXPERIENCE SPACE SWITCHING PROGRAM AND RECORDING MEDIUM WITH THE SAME RECORDED THEREIN

(71) Applicant: ABAL INC., Meguro-ku, Tokyo (JP)

(72) Inventor: Yoshiya OKOYAMA, Meguro-ku, Tokyo (JP)

(21) Appl. No.: 18/839,156

(22) PCT Filed: Oct. 19, 2023
(86) PCT No.: PCT/JP2023/037877

§ 371 Date: Aug. 16, 2024

(51) Int. Cl. G06T 19/00; G06T 13/40; G06T 19/20; G06V 40/20

(52) U.S. Cl. CPC G06T 19/006; G06T 13/40; G06T 19/20; G06V 40/20; G06T 2219/2004; G06V 2201/07

(57) ABSTRACT

A system S comprises a server 3 and HMDs 4. The server 3 comprises a composite space generation unit 31b that generates composite space, a user environment determination unit 32 that determines space to be recognized by each user via his HMD 4, a user state recognition unit 33 that recognizes a motion of the user, a trigger event recognition unit 35 that recognizes a trigger event which is a motion performed by the user to a virtual object, and a virtual space generation unit 37b that generates virtual space. When the trigger event is recognized, the user environment determination unit 32 causes the user to recognize the virtual space instead of the composite space.

### TECHNICAL FIELD

The present invention relates to an experience space switching method executed by a computer system for switching space to be experienced by a user via an environment output device, an experience space switching system which is the computer system, an experience space switching apparatus which is the computer system, an experience space switching program for causing the computer system to execute the experience space switching method, and a recording medium in which the program is recorded.

### BACKGROUND ART

Conventionally, there have been virtual space experience systems that generate virtual space by a server or the like, cause a user to recognize an image of the virtual space via a head-mounted display (hereinafter also referred to as “HMD”) and cause the user to recognize that the user himself exists in the virtual space.

As this kind of virtual space experience system, there exists such a system that, when a predetermined trigger event (for example, a predetermined motion of a user) is recognized, changes the environment of virtual space to be experienced by a user (for example, the position of the user's viewpoint in the virtual space) (see, for example, Patent Literature 1).

### CITATION LIST

### Patent Literature

Patent Literature 1: Japanese Patent Laid-Open No. 2020-177607

### SUMMARY OF INVENTION

### Technical Problem

The virtual space experience system according to Patent Literature 1, however, only makes it possible to switch the environment to be experienced by a user from a first-person viewpoint to a third-person viewpoint inside in certain virtual space. That is, the switching of the environment in the virtual space to be experienced by a user is merely switching that can also be realized in actual space.

Therefore, in the virtual space experience system according to Patent Literature 1, there is a problem that, even if switching of the environment of virtual space to be experienced by a user is performed, it is not possible to cause the user to sufficiently experience such an environment that cannot be experienced in real space.

The present invention has been made in view of the above problem, and an object is to provide an experience space switching method capable of causing an environment that cannot be experienced in real space to be experienced sufficiently, an experience space switching system, an experience space switching apparatus, an experience space switching program, and a recording medium with the experience space switching program recorded therein.

### Solution to Problem

In the description below, “composite space” is so-called mixed reality space (MR space) that makes a virtual object exist in real space and enables a user existing in the real space to affect the virtual object (for example, to move the virtual object).

Further, “virtual space” is so-called virtual reality space (VR space) which is virtual space that a user recognizes instead of real space where the user himself exists. In the virtual space, virtual objects, and an avatar that performs a motion according to a motion of the user may be arranged.

An experience space switching method of the present invention is an experience space switching method for switching space to be recognized by a user via an environment output device, the method being executed by a computer system, and the method comprising the steps of:

a real space recognition unit recognizing real space where the user exists;

a virtual object generation unit generating a virtual object to be recognized by the user;

a composite space generation unit generating composite space which is the real space with the virtual object existing therein;

a user environment determination unit determining an environment of the composite space to be recognized by the user via the environment output device;

a user motion recognition unit recognizing a motion of the user in the real space;

a trigger event recognition unit recognizing a predetermined trigger event which is a motion that the user performs to the virtual object;

a virtual space generation unit generating virtual space when the predetermined trigger event is recognized; and

the user environment determination unit determining, instead of the environment of the composite space experienced by the user before the predetermined trigger event is recognized, an environment of the virtual space to be recognized by the user via the environment output device.

Thus, in the experience space switching method of the present invention, before a predetermined trigger event is recognized, an environment to be recognized by a user is determined based on composite space, and the user experiences the composite space. On the other hand, after the predetermined trigger event is recognized, the environment to be experienced by the user is determined based on virtual space, and the user experiences the virtual space.

That is, this experience space switching method is capable of switching the environment to be experienced by the user between the composite space that is real space where a virtual object is made to exist and the virtual space separated from the real space, without distinguishing between the composite space and the virtual space.

Here, the trigger event to be a switching trigger is a motion performed by the user to the virtual object existing in the composite space. Since the virtual object is virtual, it is suggestive of association with the virtual space though existing in the real space.

Therefore, it is easy for the user who has performed the motion to the virtual object to unconsciously recognize that the space is to be switched, with the virtual object as a trigger. As a result, switching from the composite space to the virtual space can be performed without giving a feeling of discomfort to the user.

Therefore, according to the present experience space switching method, an environment to be experienced by a user is not limited to composite space or virtual space as before and can be space where the composite space and the virtual space are mixed. Further, since it is possible to perform switching from the composite space to the virtual space without giving a feeling of discomfort to the user, it is possible to prevent the immersive feeling of the user from being hindered by the switching. Therefore, according to this experience space switching method, it is possible to cause the user to experience an environment that he cannot experience in the real space wider than before.

Further, it is preferable that the experience space switching method of the present invention comprises the steps of:

a target person recognition unit recognizing, from among a plurality of persons existing in the real space, the user who is a target person for whom switching of a type of space to be experienced is performed, and a non-target person for whom the switching of the type of the space to be experienced is not performed; and

an avatar generation unit generating a first avatar that performs a motion according to a motion of the user and a second avatar that performs a motion according to a motion of the non-target person, and that

the environment of the virtual space to be recognized by the user includes the first avatar and the second avatar.

A configuration may be made in which, at the time of executing the experience space switching method of the present invention, a plurality of users existing in the same area of real space are caused to experience certain composite space, and, furthermore, only space to be experienced by a part of the plurality of users (target persons) is switched to virtual space. Further, a configuration may be made in which persons caused to experience composite space and virtual space (target persons) and persons not caused to experience the virtual space or the composite space (non-target persons) can exist in the same area in real space at the same time.

In the case of making such a configuration, however, when switching of the type of space to be experienced by users who are the target persons is performed, it becomes impossible for the users who are the target persons to recognize the non-target persons, and, therefore, there is a possibility that, after the switching is performed, a user who is a target person comes into contact with a non-target person unintentionally.

Therefore, it is better to, even in the case where only space to be experienced by a user who is a target person is switched as above, include not only a first avatar corresponding to the user who is the target person but also a second avatar corresponding to a non-target person in the virtual space after switching.

Thereby, it becomes possible for the first user to grasp a position of the non-target person through the second avatar, and, therefore, it is possible to prevent the first user from coming into contact with the non-target person unintentionally. Further, it is also possible to prevent the immersive feeling of the first user from being hindered.

Further, in the experience space switching method of the present invention, it is preferable that

the virtual object has an attribute corresponding to an attribute of the virtual space generated when the predetermined trigger event is performed to the virtual object.

Here, the “attribute” is the shape, pattern, or color of the virtual space, or a combination thereof. The attribute of the virtual object and the attribute of the virtual space may be those that are suggestive of association with each other, in addition to those that correspond to each other. Specifically, for example, in addition to making the pattern of the background of virtual space and the pattern of the virtual object to correspond to each other, forming the shape of a virtual object a “building” when virtual space is space imitating an “office”, and the like are exemplified.

Thus, by making such a configuration so that the attribute of a virtual object to be a trigger of a trigger event, and the attribute of virtual space, which is generated with the trigger event as a trigger correspond to each other, a user who causes the trigger event to occur via the virtual object can unconsciously predict the attribute of the virtual space into which the user moves after that. Thereby, it is further possible to switch the type of space to be experienced without giving the user a feeling of discomfort.

Further, in the experience space switching method of the present invention, it is preferable that

a shape of the virtual space is generated according to a shape of the real space at a point of time when the trigger event is recognized.

There are various shapes (for example, types of arranged pieces of furniture) of the real space, and the shape may change as time passes. Therefore, if the virtual space with a fixed shape is generated irrespective of the shape of the real space, there is a possibility that the range in which a motion can be performed may differ in the same virtual space according to the shape of the real space. Therefore, there is a possibility that a user may be given a feeling of discomfort.

Therefore, by making the shape of virtual space to be generated correspond to the shape of real space at the point of time when a trigger event to be a trigger of generation of the virtual space is recognized, as described above, it is possible to cause the range in which a motion can be performed in the generated virtual space to correspond to the real space. Thereby, it is possible to prevent the user from being given a feeling of discomfort due to difference between the shape of the virtual space and the shape of the real space.

Further, it is preferable that the experience space switching method of the present invention comprises:

the virtual space generation unit generating space where the composite space and the virtual space are mixed; and

the user environment determination unit determining, after determining an environment of the space where the composite space and the virtual space are mixed, which is to be recognized by the user via the environment output device, instead of the environment of the composite space experienced by the user before the predetermined trigger event is recognized, the environment of the virtual space to be recognized by the user via the environment output device.

By making such a configuration, it is possible to prevent an abrupt feeling that may be given to a user at the time of switching the space to be experienced from composite space to virtual space. Therefore, it is further possible to perform switching of the type of space to be experienced without giving a feeling of discomfort to the user.

An experience space switching system of the present invention is a computer system executing any of the above experience space switching methods.

An experience space switching apparatus of the present invention is a computer system executing any of the above experience space switching methods.

An experience space switching program of the present invention causes a computer system to execute any of the above experience space switching methods.

A recording medium of the present invention is a recording medium with the above experience space switching program recorded therein, the experience space switching program being readable by the computer system.

### BRIEF DESCRIPTION OF DRAWINGS

FIG. 1 is a schematic diagram showing a schematic configuration of a space experience system according to an embodiment.

FIG. 2 is a block diagram showing a configuration of processing units of the space experience system of FIG. 1.

FIG. 3 is a schematic diagram showing an example of composite space generated by the space experience system of FIG. 1.

FIG. 4 is a schematic diagram showing an example of virtual space generated by the space experience system of FIG. 1.

FIG. 5 is a schematic diagram showing a shape of the virtual space generated by the space experience system of FIG. 1 and a shape of real space corresponding thereto.

FIG. 6 is a schematic diagram showing a state of space that the space experience system of FIG. 1 causes a user to recognize at the time of switching space to be experienced by the user.

FIG. 7 is a flowchart showing a process that the space experience system of FIG. 1 executes in a state of causing the user to experience the composite space.

FIG. 8A is a flowchart showing a first-half process of a process that the space experience system of FIG. 1 executes at the time of switching the space to be experienced by the user.

FIG. 8B is a flowchart showing a second-half process of the process that the space experience system of FIG. 1 executes at the time of switching the space to be experienced by the user.

FIG. 9 is a flowchart showing a process that the space experience system of FIG. 1 executes in a state of causing the user to experience the virtual space.

### DESCRIPTION OF EMBODIMENT

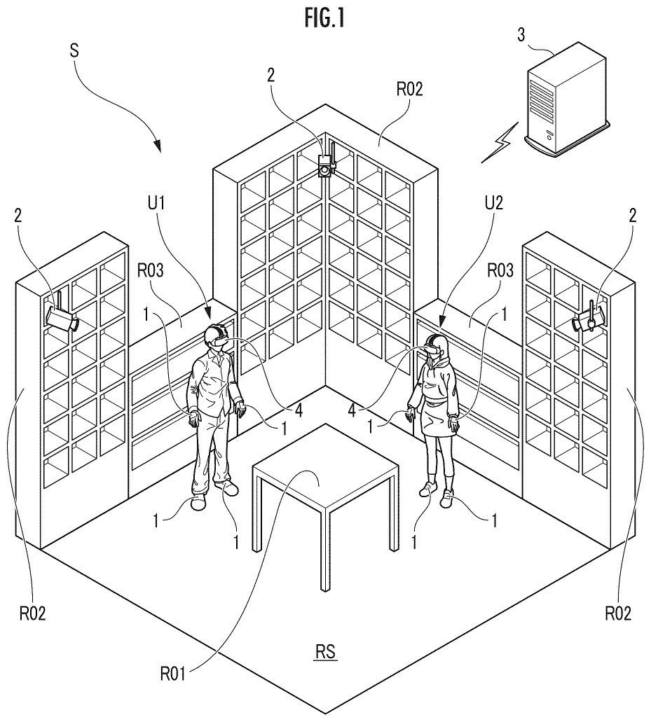

A system S (an experience space switching system) according to an embodiment and a process (an experience space switching method) executed by the system S will be described below with reference to FIGS. 1 to 9.

The system S is a computer system for causing a first user U1 and a second user U2 (hereinafter referred to as “users U” when being generically referred to) existing together in a predetermined area (for example, one room; see FIG. 1) in real space RS to experience composite space MS or virtual space VS.

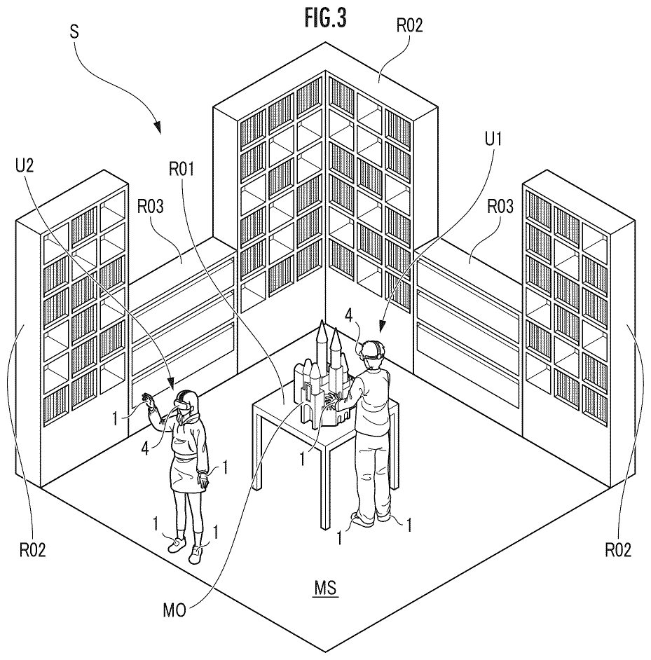

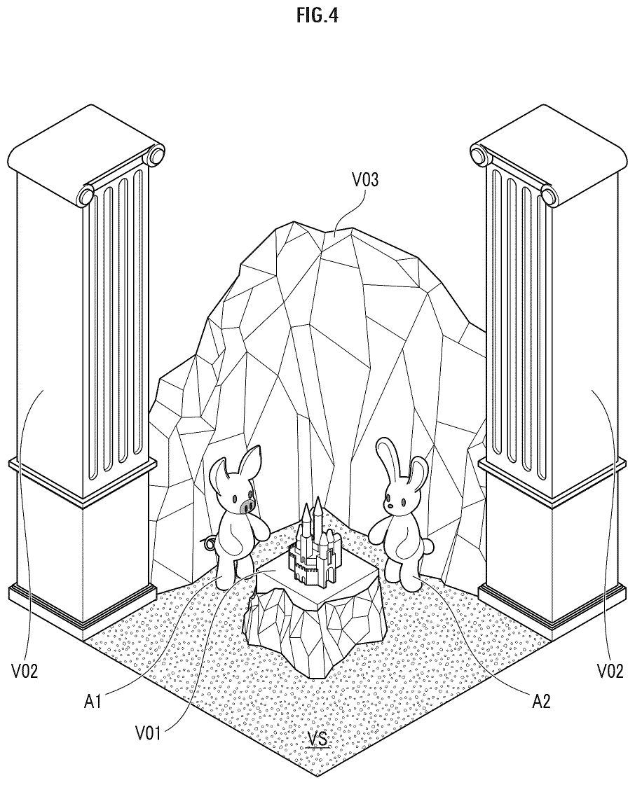

By causing the users U to recognize environments (for example, images and sounds) of the composite space MS (see FIG. 3) corresponding to the real space RS, the system S causes the users U to recognize that they are experiencing the composite space MS (for example, recognize that they themselves exist there). Further, by causing a target user U to recognize an environment of the virtual space VS (see FIG. 4) corresponding to the real space RS, with a predetermined trigger event as a trigger, the system S causes the user U to experience the virtual space VS.

Here, “composite space” is so-called mixed reality space (MR space) that makes a virtual object exist in real space and enables a user existing in the real space to affect the virtual object (for example, to move the virtual object).

Further, “virtual space” is virtual space that a user recognizes instead of real space where the user himself exists, and is so-called virtual reality space (VR space). In the virtual space, virtual objects, and an avatar that performs a motion according to a motion of the user may be arranged.

In the present embodiment, there are two users, the first user U1 and the second user U2 to make understanding easy. The number of users to use the experience space switching system of the present invention, however, is not limited to such a configuration, and may be one, or three or more.

### Schematic Configuration of System

First, a schematic configuration of the system S will be described with reference to FIG. 1.

As shown in FIG. 1, the system S comprises a plurality of signs 1 attached to the users U existing in the real space RS, cameras 2 for shooting images of the users U (strictly, the signs 1 attached to the users U), a server 3 (an experience space switching system) that determines environments of the composite space MS or the virtual space VS1 to be experienced by the users U, head-mounted displays (hereinafter referred to as “HMDs 4”) which are environment output devices that cause the users to recognize the determined environments.

In the system S, the cameras 2, the server 3, and the HMDs 4 are capable of wirelessly transmitting/receiving information with one another via the Internet network, a public line, near-field communication, or the like. Some of them, however, may be configured to be capable of wiredly transmitting/receiving information with one another.

The plurality of signs 1 are attached to the head, both hands, and both feet of each user U via the HMD 4, gloves, and shoes worn on the user U. The plurality of signs 1 are used to recognize motions of the users U in the real space RS as described later. Therefore, the positions of and the number of signs 1 to be attached may be appropriately changed according to other pieces of equipment constituting the system S.

The cameras 2 are installed such that it is possible to shoot images of a range in which the users U can perform motions (that is, a range in which the users U can move and perform motions) in the real space RS where the users U exist, from many directions.

The server 3 (the experience space switching system) recognizes (for example, detects or calculates) the signs 1 from images shot by the cameras 2, and recognizes motions (for example, change in postures and coordinates) of the users U based on positions of the recognized signs 1 in the real space RS. Further, the server 3 determines environments of the composite space MS or the virtual space VS to be recognized by the users U, based on the motions.

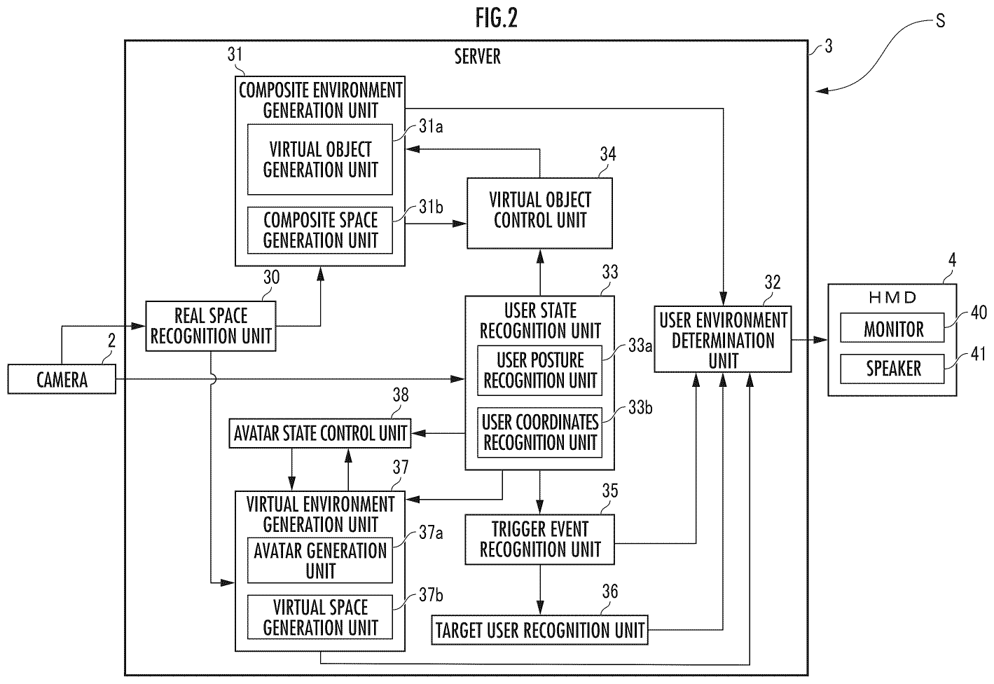

The HMDs 4 are environment output devices that output environments (for examples, images and voices) of the composite space MS or the virtual space VS to cause the users to recognize the environments. The HMDs 4 are attached to the heads of the users U. The HMDs 4 have monitors 40 for causing the users U to recognize images in the composite space MS or the virtual space VS determined by the server 3, and speakers 41 for causing the users U to recognize a sound in the composite space MS or the virtual space VS determined by the server 3, respectively (see FIG. 2).

The monitors 40 are such that, in a state of causing the users U to experience the composite space MS, it is possible to observe the real space RS through the monitors 40.

In the case of causing the users U to experience the composite space MS using the system S, the users U are caused to recognize an image and a sound of a virtual object corresponding to the composite space MS experienced by the users U, together with images and sounds in the real space RS. The virtual object is configured to perform a predetermined motion (for example, movement of coordinates) according to a motion of a user U.

In the case of causing a user U to experience the virtual space VS using the system S, the user U is caused to recognize only images and sounds in the virtual space VS via the HMD 4 and caused to recognize that he exists in the virtual space VS. That is, the system S is configured as a so-called immersive system.

The experience space switching system of the present invention is not limited to the configuration using signs and cameras as described above (a so-called motion capture apparatus) and only needs to be configured to be capable of recognizing real space and motions of users.

Therefore, for example, a system with a configuration in which the number and arrangement of signs and cameras are different from those shown in FIG. 1 may be used. Specifically, in order to recognize at least either characteristic points of users or characteristic points of real space, signs may be attached not only to the users but also to real objects existing in the real space. Characteristic points may be recognized from images themselves without using signs.

Further, for example, sensors such as GPS may be mounted on HMDs instead of signs and cameras so that motions of users can be recognized based on outputs from the sensors. Further, such sensors and the motion capture apparatuses as described above may be used together.

The experience space switching system of the present invention is not limited to such that is configured with one server and only needs to be configured such that any apparatus constituting the experience space switching system comprises processing units to be described later.

Therefore, for example, the whole experience space switching system may be configured with a plurality of servers. Further, it is also possible to, by implementing the cameras, HMDs, or other apparatuses with at least one of the processing units or at least a part of functions of the processing units, configure the system with the apparatuses and a server working in cooperation, or only with the apparatuses.

### Configurations of Processing Units

Next, configurations of the processing units constituting the system S will be described with reference to FIGS. 1 to 6.

Each of the cameras 2, the server 3, and the HMDs 4 constituting the system S is configured with one or more electronic circuit units including a CPU, a RAM, a ROM, an interface circuit, and the like.

As shown in FIG. 2, the server 3 comprises, as functions (processing units) realized by at least either implemented hardware components or programs, a real space recognition unit 30, a composite environment generation unit 31, a user environment determination unit 32, a user state recognition unit 33 (a user motion recognition unit), a virtual object control unit 34, a trigger event recognition unit 35, a target user recognition unit 36 (a target person recognition unit), a virtual environment generation unit 37, and an avatar state control unit 38.

The real space recognition unit 30 recognizes image data of the real space RS shot by the cameras 2, and recognizes a situation of the real space RS based on the image data. The situation of the real space RS is, for example, postures, coordinates, and the like of the users U and real objects (in the present embodiment, a table RO1, bookshelves RO2, drawer chests RO3) existing in the real space RS.

The composite environment generation unit 31 comprises a virtual object generation unit 31a and a composite space generation unit 31b.

The virtual object generation unit 31a generates virtual objects that are made to exist in the composite space MS and caused to be recognized by the users U (in the present embodiment, a model MO, which is a virtual object of a model of a castle, objects of virtual books packed in the bookshelves RRO2, and the like) (see FIG. 3 and the like). The virtual objects include such that performs a motion according to a motion of a user U in the composite space MS (for example, such that the posture and coordinates thereof can be changed in the composite space MS).

The composite space generation unit 31b makes the virtual objects generated by the virtual object generation unit 31a exist in the real space RS recognized by the real space recognition unit 30 and generates such composite space MS as shown in FIG. 3.

Here, the monitors 40 mounted on the HMDs 4 are such that it is possible to observe the real space RS through the monitors 40. Therefore, at the time of causing the determined composite space MS to be experienced by the users U, the determined virtual objects are displayed, being superimposed on the real space RS recognized through the monitors 40, and the speakers 41 mounted on the HMDs 4 are made to generate determined sounds.

Therefore, the composite space generation unit 31b indirectly generates the composite space by determining postures and coordinates of the virtual objects in the real space RS observed by the users U through the monitors 40 of the HMDs 4 and determining sounds to be generated, based on the virtual objects.

As for a process for generating composite space, it is also possible to, without using real space that is observed by users through his HMDs, generate an image, which is an image of real space acquired by a camera or the like provided on each HMD, with virtual objects superimposed thereon, and setting the image as the composite space.

The user environment determination unit 32 determines an environment of the composite space MS or the virtual space VS to be recognized by a user U via the monitor 40 and the speaker 41 of his HMD 4.

Here, the “environment to be recognized” by a user refers to an environment of composite space or virtual space to be experienced by the user through his five senses. For example, the environment is an environment configured with images of virtual objects existing in composite space or virtual space to be recognized by the user, and sounds and the like generated based on the virtual objects.

The user state recognition unit 33 (the user motion recognition unit) recognizes image data of the users U shot by the cameras 2, and recognizes states of the users U in the real space RS based on the image data. Here, the states of the users U in the real space RS are postures and coordinates of the users U and, therefore, motions of the users U shown by amounts of change in the postures and the coordinates. The user state recognition unit 33 has a user posture recognition unit 33a and a user coordinates recognition unit 33b.

The user posture recognition unit 33a extracts characteristic points of the bodies and the like of the users U from the inputted image data of the users U, and recognizes postures of the users U in the real space RS based on a result of the extraction.

The user coordinates recognition unit 33b recognizes coordinates of the users U in the real space RS, based on the result of the extraction of the characteristic points of the bodies and the like of the users U extracted from the inputted image data of the users U, and a situation of the real space RS recognized by the real space recognition unit 30 (for example, coordinates of the real objects and the like).

Based on a motion of a user U in the real space RS recognized by the user motion recognition unit, the virtual object control unit 34 controls a state of a virtual object existing in the composite space MS being experienced by the user U.

Specifically, when the user U performs some motion to a virtual object, the virtual object control unit 34 makes the posture, coordinates, shape and the like of the virtual object in the composite space MS change according to the motion.

The trigger event recognition unit 35 recognizes that a predetermined trigger event has occurred when a condition specified by a system designer or the like in advance is satisfied. In the present embodiment, a motion of any of the users U touching a virtual object is set as the predetermined trigger event.

The predetermined trigger event of the present invention is not limited to such a configuration, and may be any motion performed by a user to a virtual object.

Therefore, for example, the predetermined trigger event may be such that is not the motion of touching a virtual object. Specifically, the predetermined trigger event may be a motion of pointing to a virtual object, a motion of selecting a virtual object via a virtual or real tablet or the like.

Further, for example, the predetermined trigger event may be such that a user does not recognize occurrence thereof. Specifically, the trigger event may be such that is not caused by a user's intention, such as elapse of a predetermined period of time (for example, stopping for the predetermined period of time inside a certain range of area from a virtual object).

Based on the type of the recognized trigger event and the motion of the user U at the time of occurrence of the trigger event, the target user recognition unit 36 recognizes a first user (a target person) for whom switching of the type of space to be experienced, which is to be described later, is performed and a second user (a non-target person) for whom switching of the type of space to be experienced is not performed.

In the present embodiment, a user U who has performed a motion of touching a virtual object set as a trigger of a trigger event in advance (in the present embodiment, the model MO which is a virtual object of a castle model), among the virtual objects is recognized as the first user U1, and another user is recognized as the second user U2.

The target user recognition unit in the present invention is not limited to such a configuration, and only needs to recognize, among a plurality of users, first users for whom switching of the type of space to be experienced is performed and second users for whom switching of the type of space to be experienced is not performed. Therefore, how a first user and a second user are distinguished may be appropriately set by a system designer.

For example, a configuration may be made in which a predetermined group is set in advance, and, when one of users belonging to the group causes a trigger event, the space to be experienced by all the users belonging to the group is switched (that is, all the users belonging to the group are recognized as the first users).

Further, in the present embodiment, since the plurality of users exist, the process for recognizing the first user, who is a target person for whom switching of the type of space to be experienced is performed and the second user, who is a non-target person for whom switching of the type of space to be experienced is not performed is performed.

This is because, when the predetermined trigger event is recognized by a motion of one user (the first user), and the type of space to be experienced is switched, in a case where the plurality of users are not mutually acquainted, the space that is being experienced by the other user (the second user) is suddenly switched, and there is a possibility that the second user may be given a feeling of discomfort.

Therefore, in a case where there is only one user who is experiencing space using the experience space switching system, a case where a plurality of users are mutually acquainted, and there is no problem even if space to be experienced by all the users is switched due to a motion of one user, or the like, it is not necessary to execute the process for recognizing the first and second users, and the target user recognition unit may be omitted.

The virtual environment generation unit 37 comprises an avatar generation unit 37a and a virtual space generation unit 37b.

The avatar generation unit 37a generates avatars to exist in the virtual space VS when the predetermined trigger event described before is recognized.

The avatars include a first avatar A1 corresponding to the first user U1 and a second avatar A2 corresponding to the second user U2 (see FIG. 4). The first avatar A1 and the second avatar A2 (hereinafter, referred to as “avatars A” when being generically referred to) perform motions in the virtual space VS according to motions of the corresponding users U in the real space RS.

In the present embodiment, in the case of causing a user U to experience the virtual space VS using the system S, the user U recognizes only images and sounds in the virtual space VS and are caused to recognize that he exists in the virtual space VS. That is, the system S is configured as a so-called immersive system.

The space switching system of the present invention, however, is not limited to such a configuration, and avatars does not have to exist in virtual space. That is, the system for causing virtual space to be experienced in the space switching system of the present invention does not necessarily have to be an immersive system.

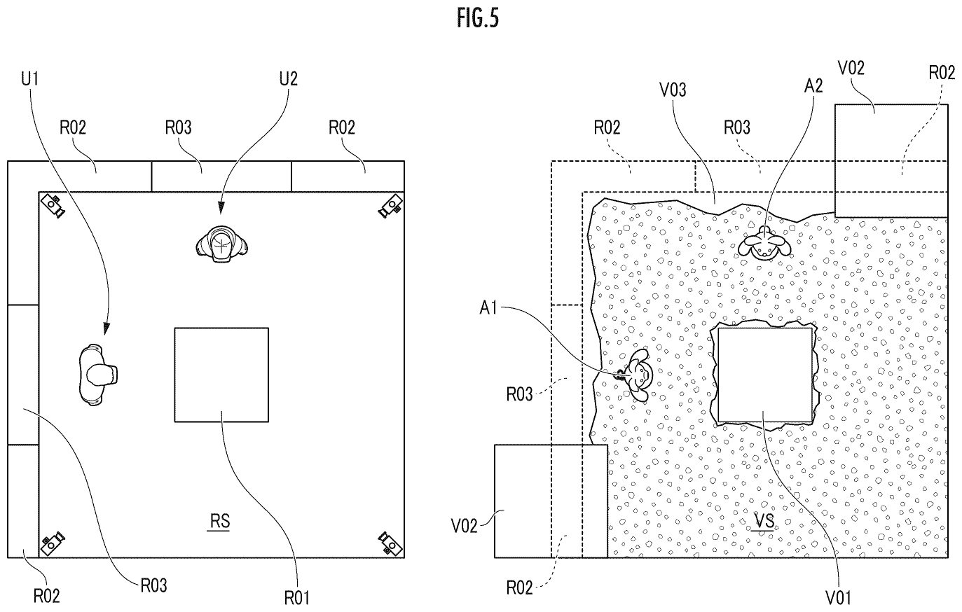

When the predetermined trigger event described before is recognized, the virtual space generation unit 37b generates such virtual space VS corresponding to the real space RS where the users U exist (see FIGS. 1 and 5) as shown in FIG. 4. Specifically, the virtual space generation unit 37b generates a background of the virtual space VS, images to be the virtual objects and the avatars A that exist in the virtual space VS, and sounds related to the images.

If the space switching system comprises a configuration that realizes predetermined feels (for example, a feel of a cushion the hardness of which changes), a configuration that generates predetermined smells, and the like, which the system S of the present embodiment does not comprise, the virtual space generation unit may generate virtual space using the feels and smells in addition to images and sounds.

As shown FIG. 5, a configuration is made so that the shape of the virtual space VS generated by the virtual space generation unit 37b is generated according to the shape of the real space RS at a point of time of a trigger event being recognized.

Here, the “shape of real space” is recognized based on the shape of an area where virtual space is generated, and postures, coordinates, shapes, and the like of real objects existing in the real space (for example, in the present embodiment, the table RO1, the bookshelves RO2, and the drawer chests RO3).

Further, in such an immersive as in the present embodiment, the “shape of virtual space” refers to an area where avatars corresponding to users can perform motions. Specifically, a range defined by an image of a background of the virtual space VS and virtual objects arranged in the virtual space.

There are various shapes of the real space RS, and the shape may change as time passes. Therefore, if the virtual space VS with a fixed shape is generated irrespective of the shape of the real space RS, there is a possibility that the range in which a motion can be performed differs according to the shape of the real space RS in the same virtual space VS. Therefore, there is a possibility that a user U may be given a feeling of discomfort.

Therefore, by making the shape of the virtual space VS to be generated correspond to the shape of the real space RS at the point of time when a trigger event to be a trigger of generation of the virtual space VS is recognized, as described above, it is possible to cause the range in which a motion can be performed in the generated virtual space VS to correspond to the real space RS. Thereby, it is possible to prevent the user U from being given a feeling of discomfort due to difference between the shape of the virtual space VS and the shape of the real space RS.

In the present embodiment, the size of an image of the background of the virtual space VS corresponds to the area of the real space RS, and a rock VO1, rock walls VO2, and pillars VO3, which are virtual objects, are generated in the virtual space VS according to coordinates and shapes of the table RO1, the bookshelves RO2, and the drawer chests RO3.

The space switching system of the present invention is not limited to such a configuration, and the shape of generated virtual space and the shape of real space do not necessarily have to correspond to each other. For example, if the system for causing virtual space to be experienced in the space switching system is not of an immersive type, movement of users does not occur, and, therefore, the shape of virtual space may be different from the shape of real space.

Here, the attribute of the virtual space VS generated by the virtual space generation unit 37b corresponds to the attribute of a virtual object that has triggered generation of the virtual space VS (in the present embodiment, the model MO which is a virtual object of a castle model).

Here, the “attribute” is the shape, pattern, or color of virtual space, or a combination thereof. The attribute of the virtual object and the attribute of the virtual space may be those that are suggestive of association with each other, in addition to those that correspond to each other. Specifically, for example, in addition to making the pattern of the background of virtual space and the pattern of the virtual object correspond to each other, forming the shape of a virtual object as a “building” when virtual space is space imitating an “office”, and the like are exemplified.

Thus, by making such a configuration so that the attribute of the model MO, which is a virtual object to be a trigger of a trigger event, and the attribute of the virtual space VS, which is generated with the trigger event as a trigger correspond to each other, a user U who causes the trigger event to occur via the model MO can unconsciously predict the attribute of the virtual space VS into which the user U moves after that. Thereby, it is further possible to switch the type of space to be experienced without giving the user U a feeling of discomfort.

Though the description is made on the assumption that only the model MO exists as a virtual object to be a trigger of a trigger event in order to make understanding easy in the present embodiment, there may be a plurality of such virtual objects.

If a plurality of such virtual objects exist, and the attributes of the virtual objects (therefore, the attributes of virtual spaces generated based on the virtual objects) are made to be different from one another, it becomes possible for a user himself to select virtual space to be switched to, only by an easy motion of selecting a virtual object.

The space switching system of the present invention is not limited to such a configuration, and the attribute of a virtual object to be a trigger of a trigger event and the attribute of the trigger event do not necessarily have to correspond to each other.

However, if switching of the type of space to be experienced occurs at a timing that is not intended by the user, the user is given a feeling of discomfort. Therefore, it is better to explicitly or implicitly show that, if some motion is performed to a certain virtual object, switching of the type of space to be experienced occurs. It is better to devise some measure, for example, generating a virtual message board near the virtual object, and giving information about virtual space to be switched to when the virtual object is touched on the message board.

Further, the space switching system of the present invention may be configured to generate virtual space corresponding to a predicted state (a shape or the like) of real space in advance for each virtual object to be a trigger of a trigger event; and, when recognizing a trigger event, select virtual space according to the type of the trigger event and the state of the real space, and cause a target user to experience the selected virtual space, though this configuration is not adopted by the system S of the present embodiment.

Based on a state (that is, a posture and coordinates) of each user U in the real space RS recognized by the user state recognition unit 33, the avatar state control unit 38 controls a state of an avatar A corresponding to the user U in the virtual space VS.

In the system S comprising such processing units, before the predetermined trigger event is recognized, environments to be recognized by the users U are determined based on the composite space MS, and both users U experience the composite space MS.

On the other hand, after the predetermined trigger event is recognized, environments to be experienced by the users U are determined based on virtual space, and, therefore, the first user U1 who has generated the trigger event, between the users U, experiences the virtual space VS instead of the composite space MS that he has experienced so far.

That is, the system S is capable of switching the environment to be experienced by a user U between the composite space MS that is the real space RS where a virtual object is made to exist and the virtual space VS separated from the real space RS, without distinguishing between the composite space MS and the virtual space VS.

Here, the trigger event to be a switching trigger is a motion performed by a user U to a virtual object existing in the composite space MS (in the present embodiment, the model MO which is a virtual object of a castle model). Since the model MO is a virtual object, it is suggestive of association with the virtual space VS though it exists in the real space RS.

Therefore, it is easy for a user U who has touched the model MO to unconsciously recognize that the space is to be switched, with the virtual object as a trigger. As a result, switching from the composite space MS to the virtual space VS can be performed without giving a feeling of discomfort to the user U.

Therefore, according to the system S, an environment to be experienced by a user U is not limited to the composite space MS or the virtual space VS as before and can be space where the composite space MS and the virtual space VS are mixed. Further, since it is possible to perform switching from the composite space MS to the virtual space VS without giving a feeling of discomfort to the user U, it is possible to prevent the immersive feeling of the user U from being hindered by the switching. Therefore, according to the system S, it is possible to cause the user U to experience an environment that he cannot experience in the real space RS wider than before.

Switching from composite space to virtual space may be performed immediately after the process for generating the virtual space is completed after a trigger event is recognized, or may be performed after causing a user for whom the switching of the type of space to be experienced is performed (the first user) to experience space where the composite space and the virtual space are mixed once.

By making such a configuration, it is possible to prevent an abrupt feeling that may be given to a user at the time of switching the space to be experienced from composite space to virtual space. Therefore, it is further possible to perform switching of the type of space to be experienced without giving a feeling of discomfort to the user.

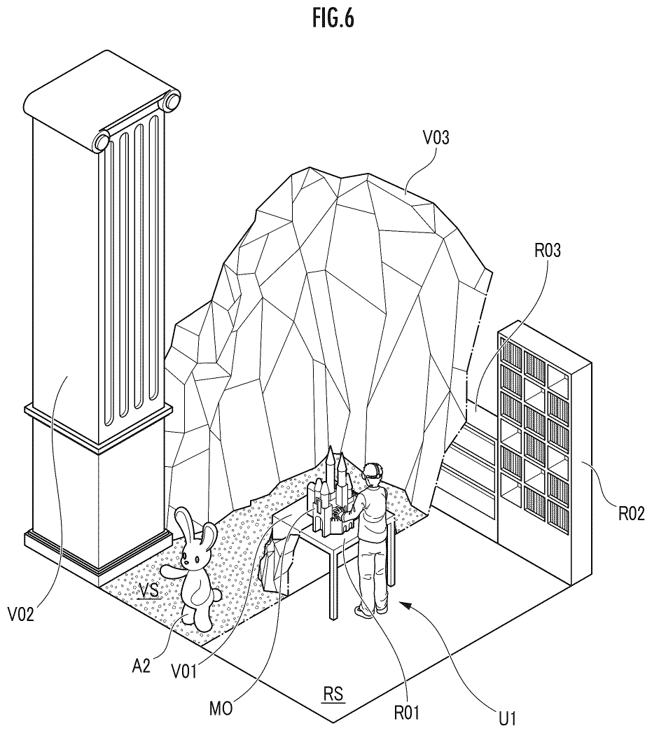

For example, in the present embodiment, after the process for generating virtual space is completed, the first user U1 is caused to experience once such space that the composite space MS is painted with the virtual space VS from a predetermined starting point (in the present embodiment, the left side of the composite space MS on the drawing), and the users U including the first user U1 himself are replaced by the avatars A, and then experience the virtual space VS, as shown in FIG. 6.

The space where composite space and virtual space are mixed is not limited to such a configuration. Therefore, for example, a configuration is also possible in which a virtual object to be a trigger of a trigger event expands as if it swallowed up users and becomes the virtual space VS.

Further, the number of types of the space where composite space and virtual space are mixed does not have to be one. There may be many types. For example, even in the case of switching to the same virtual space, the mixed space may differ according to the content of a trigger event to be a trigger (the type of a targeted virtual object, the type of a motion to the virtual object, and the like).

As described before, the system S is configured to recognize, from among a plurality of persons existing in the real space, the first user U1 who is a target person for whom switching of the type of space to be experienced is performed, and the second user U2 who is a non-target person for whom switching of the type of space to be experienced is not performed and, when a trigger event is recognized, perform only switching of the type of space to be experienced by the first user.

When the system S is configured to perform switching of the type of space to be experienced, for each user U as above, however, it becomes impossible, in the case where there are a plurality of users U in the same area in the real space RS, for the first user U1 to recognize the second user U2 when switching of the type of space to be experienced by the first user U1 is performed. Therefore, there is a possibility that, after the switching of the type of space to be experienced is performed, the first user U1 comes into contact with the second user U2 unintentionally.

Further, it is also conceivable to make a configuration in which a person caused to experience composite space and virtual space (a target person) and a person not caused to experience the virtual space or the composite space (a non-target person) can exist in the same area in real space at the same time. In such a case also, when switching of the type of space to be experienced by the target persons is performed, it becomes impossible for the target persons to recognize the non-target persons, and, therefore, there is a possibility that, after the switching is performed, a target person comes into contact with a non-target person unintentionally.

Therefore, as shown in FIG. 4, the system S is configured such that, even in the case where only space to be experienced by the first user U1 is switched, not only the first avatar A1 corresponding to the first user U1, who is a target person, but also the second avatar A2 corresponding to the non-target person like the second user U2 are included in the switched virtual space VS.

Thereby, it becomes possible for the first user U1 to grasp a position of a non-target person like the second user U2 through the second avatar U2, and, therefore, it is possible to prevent the first user U1 from coming into contact with the non-target person like the second user U2 unintentionally. Further, it is also possible to prevent the immersive feeling of the first user U1 from being hindered.

The experience space switching system of the present invention is not limited to such a configuration. For example, when real space is sufficiently large, or when a movement route is fixed, the possibility of users coming into contact with each other is low even if only space to be experienced by a target person is switched. Therefore, a second avatar corresponding to a non-target person for whom switching of the type of space to be experienced is not performed does not necessarily have to be included in virtual space.

In the present embodiment, such a configuration is made that both of the first avatar A1 that performs a motion in response to the first user U1, who is a target person and the second avatar A2 that performs a motion in response to the second user U2, who is a non-target person are animal avatars. The forms of avatars corresponding to a target person and a non-target person do not necessarily have to be the same.

For example, it is also possible to set the avatar that performs a motion in response to the target person as a deformed human being, and the avatar that performs a motion in response to the non-target person as an animal, or set the avatar that performs a motion in response to the target person as an avatar through which the background is not seen, and the avatar that performs a motion in response to the non-target person as a semitransparent avatar through which the background is seen.

By making a configuration so that the forms of avatars performing motions according to motions of a target person and a non-target person are different as above, it becomes possible for the target person who recognizes the avatars to intuitively distinguish between the avatar performing a motion according to a motion of the target person and the avatar performing a motion according to a motion of the non-target person.

### Process Executed by Each Processing Unit

Next, a description will be made on a process executed by the system S at the time of causing the users U to experience the composite space MS or the virtual space VS using the system S (that is, a space switching method) with reference to FIGS. 2 to 9.

### Process at the Time of Causing Composite Space to be Experienced

First, a description will be made on a process that the system S executes at the time of causing the users U to experience the composite space MS, with reference to FIGS. 1 to 3 and FIG. 7.

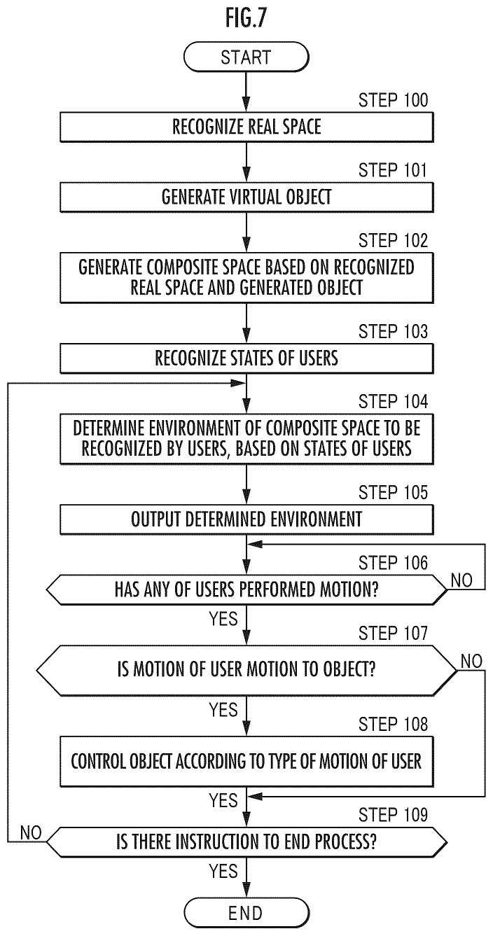

In this process, first, the real space recognition unit 30 of the server 3 recognizes a situation (see FIG. 1) of the real space RS where the users U exist (FIG. 7/STEP 100).

Next, the virtual object generation unit 31a of the composite environment generation unit 31 of the server 3 generates a virtual object that is made to exist in the composite space MS and caused to be recognized by the users U (FIG. 7/STEP 101).

In the present embodiment, the virtual object generation unit 31a generates the model MO (see FIG. 3) to be a trigger of a trigger event as the virtual object made to exist in the composite space MS.

Next, the composite space generation unit 31b of the composite environment generation unit 31 makes the virtual object generated by the virtual object generation unit 31a exist in the real space RS recognized by the real space recognition unit 30, and generates such composite space MS as shown in FIG. 3 (FIG. 7/STEP 102).

Next, the user state recognition unit 33 of the server 3 recognizes image data of the users U shot by the cameras 2, and recognizes a state of each user U (a posture and coordinates in the real space RS) based on the image data (FIG. 7/STEP 103).

Next, the user environment determination unit 32 of the server 3 determines an environment of the composite space MS to be recognized by each user U based on the state of the user U (FIG. 7/STEP 104).

Specifically, as the environment to be recognized by each user U, the user environment determination unit 32 determines a state of the virtual object to be displayed, being superimposed on the real space RS, and a sound accompanying it, based on the posture and coordinates of the user U in the real space RS.

Next, the HMD 4 worn on each user U outputs the determined environment (FIG. 7/STEP 105).

Specifically, the HMD 4 causes the determined virtual object to be displayed, being superimposed on the real space RS observed through the monitor 40 mounted on the HMD 4, and causes the speaker 41 mounted on the HMD 4 to generate the determined sound.

Next, the user state recognition unit 33 of the server 3 judges whether any of the users U has performed some motion or not (FIG. 7/STE 106).

If neither of the users U has performed a motion (in the case of NO at STEP 106), the user state recognition unit 33 repeats the judgment at a predetermined control period.

On the other hand, if any of the users U has performed a motion (in the case of YES at STEP 106), the virtual object control unit 34 of the server 3 judges whether the motion of the user U is a motion to the virtual object or not (FIG. 7/STEP 107).

If the motion of the user U is a motion to the virtual object (in the case of YES at STEP 107), the virtual object control unit 34 controls the virtual object according to the type of the motion of the user U (FIG. 7/STEP 108).

For example, if the motion of the user U is a motion of moving the virtual object, the virtual object control unit 34 changes the coordinates of the virtual object according to the content of the motion.

After executing the process for controlling the virtual object (the process of STEP 108), or if the motion of the user U is not a motion to the virtual object (in the case of NO at STEP 107), the server 3 judges whether a signal indicating an instruction to end the process has been recognized or not (FIG. 7/STEP 109).

If the signal indicating the instruction to end the process has not been recognized (in the case of NO at STEP 109), the flow returns to STEP 104, and the process at and after STEP 104 is executed again.

Specifically, first, the user environment determination unit 32 determines an environment of the composite space MS to be recognized by each user U, based on a state of the user U and a situation of the composite space MS at that point of time. Next, after the HMD 4 outputs the determined environment, the user state recognition unit 33 recognizes a motion of the user U again, and the virtual object control unit 34 controls the virtual object according to the motion of the user U.

On the other hand, if the signal indicating the instruction to end the process is recognized (in the case of YES at STEP 109), the system S ends this process.

By the above process, the users U are caused to recognize the composite space MS, which is the real space RS where the virtual object exists, by images and sounds displayed and generated by the worn HMDs 4, and are into a state of capable of operating the virtual object in the composite space MS, as shown in FIG. 3.

At this time, the composite space MS is generated based on the real space RS. Therefore, in the composite space MS recognized by one of the first user U1 and the second user U2, the other of the first user U1 and the second user U2 also exists.

### Process at the Time of Switching Space

Next, a description will be made on a process that the system S executes at the time of switching space to be experienced by the first user U1 (the experience space switching method) with reference to FIGS. 1 to 4, FIG. 6, and FIGS. 8A and 8B.

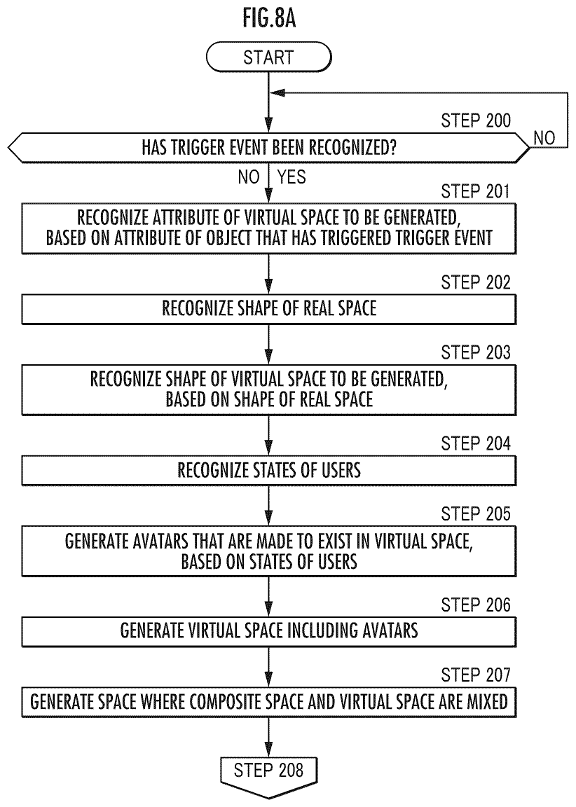

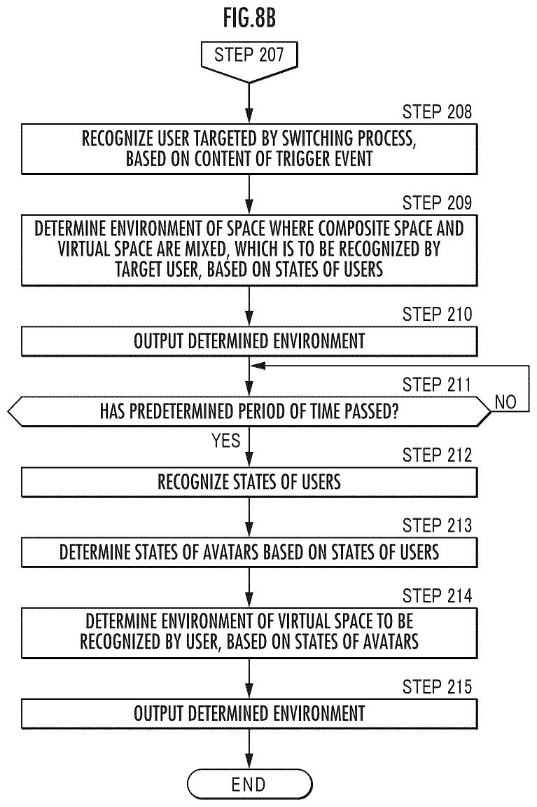

In this process, first, the trigger event recognition unit 35 of the server 3 judges whether having recognized a predetermined trigger event or not (FIG. 8A/STEP 200).

In the present embodiment, the trigger event recognition unit 35 judges whether any of the users U has performed a motion of touching the model MO, which is a virtual object to be a trigger of the trigger event, or not.

If not having recognized the trigger event (in the case of NO at STEP 201), the trigger event recognition unit 35 repeats the judgment at a predetermined control period.

On the other hand, if having recognized the trigger event (in the case of YES at STEP 200), the virtual space generation unit 37b of the virtual environment generation unit 37 of the server 3 recognizes the attribute of virtual space VS to be generated, based on the attribute of the virtual object that has triggered the trigger event (FIG. 8A/STEP 201).

In the present embodiment, since the virtual object that has triggered the trigger event is the model MO, which is a virtual object of a castle model, the virtual space VS to be generated is virtual space the theme of which is a castle. Specifically, the virtual space VS is space like a castle using nature, which is configured with the rock walls VO2, the pillars VO3 made of rocks, and the like.

Next, the virtual space generation unit 37b recognizes the shape of the real space RS (FIG. 8A/STEP 202).

Specifically, the virtual space generation unit 37b recognizes, from an image of the real space RS shot by the cameras 2 at the point of time when the trigger event was recognized, the size of the area of the real space RS where the virtual space VS is to be generated, and postures, coordinates and shapes of real objects existing in the real space RS (for example, in the present embodiment, the table RO1, the bookshelves RO2, and the drawer chests RO3).

Next, the virtual space generation unit 37b recognizes the shape of the virtual space VS to be generated based on the shape of the real space RS (FIG. 8A/STEP 203).

Specifically, the virtual space generation unit 37b recognizes the size of an image of a background of the virtual space VS based on the recognized size of the area of the real space RS, and recognizes postures, coordinates, and shapes of the virtual objects (the rock VO1, the rock walls VO2, and the pillars VO3) corresponding to the real objects based on the recognized postures, coordinates and shapes of the real objects.

Next, the user state recognition unit 33 of the server 3 recognizes states of the users U (FIG. 8A/STEP 204).

Specifically, the user state recognition unit 33 recognizes postures and coordinates of the users U in the real space RS at the point of time when the trigger event was recognized.

Next, the avatar generation unit 37a of the virtual environment generation unit 37 of the server 3 generates avatars A that are made to exist in the virtual space VS, based on the states of the users U (FIG. 8A/STEP 205).

Next, the virtual space generation unit 37b of the virtual environment generation unit 37 of the server 3 generates virtual space VS that includes the avatars generated by the avatar generation unit 37a (FIG. 8A/STEP 206).

Specifically, the virtual space generation unit 37b generates the image of the background of the virtual space VS and virtual objects based on the attribute of the virtual space VS recognized at STEP 201 and the shape of the virtual space VS recognized at STEP 203, and includes the avatars A generated at STEP 205 into the image to generate the virtual space VS as shown in FIG. 5.

Next, the user environment determination unit 32 of the server 3 generates space where the composite space MS and the virtual space VS are mixed (FIG. 8A/STEP 207).

Specifically, the user environment determination unit 32 generates space where the composite space MS that has been generated by the composite environment generation unit 31 and is currently being experienced by the users U and an image of the virtual space VS that has been generated by the virtual environment generation unit 37 and is to be experienced by any of the users U are mixed.

In the present embodiment, the mixed space is such space that the composite space MS is repainted with the virtual space VS from a predetermined starting point (in the present embodiment, the left side of the composite space MS on the drawing), and the users U themselves are replaced by the avatars A, as shown in FIG. 6.

Next, the target user recognition unit 36 of the server 3 recognizes a user to be a target of the switching process, based on the content of the trigger event (FIG. 8B/STEP 208).

Specifically, based on the type of the recognized trigger event and motions of the users U at the time of occurrence of the trigger event, the target user recognition unit 36 recognizes a user for whom switching of the type of space to be experienced is performed (a first user) and a user for whom switching of the type of space to be experienced is not performed (a second user).

In the present embodiment, a user U who has performed the motion of touching the model MO, which is a virtual object to be a trigger of a trigger event, is recognized as the first user U1, and another user is recognized as the second user U2.

Next, the user environment determination unit 32 determines an environment of the space where the composite space MS and the virtual space VS are mixed, which is to be experienced by the first user U1 targeted by switching of the type of space to be experienced, based on states of the first user U1 and the second user U2 (FIG. 8B/STEP 209).

Next, the HMD 4 worn on the first user U1 outputs the determined environment (FIG. 8B/STEP 210).

Specifically, the HMD 4 causes the monitor 40 mounted on the HMD 4 to display a determined image and causes the speaker 41 mounted on the HMD 4 to generate a determined sound.

Next, the user environment determination unit 32 judges whether a predetermined period of time has passed or not (FIG. 8B/STEP 211).

Specifically, the user environment determination unit 32 judges whether a period of time required to complete switching from the composite space MS to the virtual space VS with the space where the composite space MS and the virtual space VS are mixed between.

After that, until the predetermined period of time passes (in the case of NO at STEP 211), the user environment determination unit 32 repeats the judgment of STEP 211.

On the other hand, if the predetermined period of time has passed (in the case of YES at STEP 211), the user state recognition unit 33 of the server 3 recognizes the states of the users U again (FIG. 8B/STEP 212).

Next, the avatar state control unit 38 of the server 3 determines states of the avatars A based on the states of the users U (FIG. 8B/STEP 213).

Next, the user environment determination unit 32 of the server 3 determines an environment of the virtual space VS to be recognized by the first user U1, based on the states of the first avatar A1 of the first user U1 and the second avatar A2 of the second user U2 (FIG. 8B/STEP 214).

Specifically, the user environment determination unit 32 determines an image and a sound in the virtual space VS representing the environment of the first avatar A1 (including relative coordinates relative to the second avatar A2 corresponding to the second user U2 and the like) as the environment to be recognized by the first user U1.

Next, the HMD 4 worn on the first user U1 outputs the determined environment (FIG. 8B/STEP 215), and the system S ends the current process.

By the above process, the space to be experienced by the first user U1 is switched from the composite space MS to the virtual space VS with the space where the composite space MS and the virtual space VS are mixed between, as shown in FIGS. 3, 4, and 6. On the other hand, the space to be experienced by the second user U2 remains being the composite space MS.

### Process at the Time of Causing Virtual Space to be Experienced

Next, a description will be made on a process that the system S executes at the time of causing the first user U1 to experience the virtual space S with reference to FIGS. 1, 2, 4, and 9.

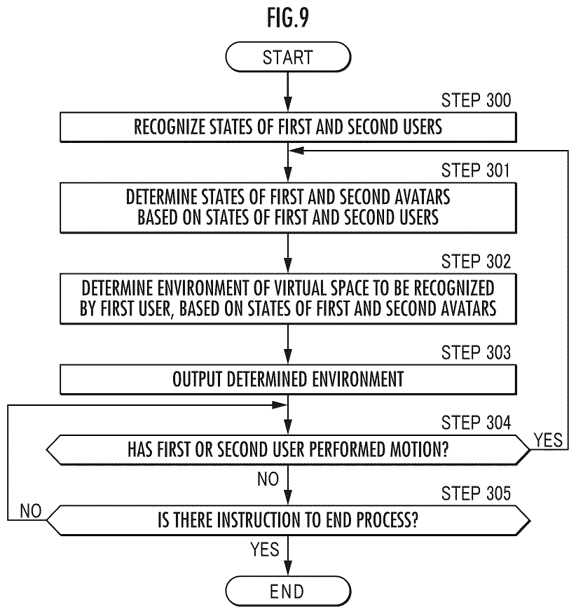

In this process, first, the user state recognition unit 33 of the server 3 recognizes image data of the users U shot by the cameras 2, and recognizes states of the first user U1 and the second user U2 (postures and coordinates in the real space RS (see FIG. 1)) based on the image data (FIG. 9/STEP 300).

Next, the avatar state control unit 38 of the server 3 determines states of the first avatar A1 and the second avatar A2 (postures and coordinates in the virtual space VS (see FIG. 4)) based on the states of the first user U1 and the second user U2 (FIG. 9/STEP 301).

Next, the user environment determination unit 32 of the server 3 determines an environment of the virtual space VS to be recognized by the first user U1, based on the states of the first avatar A1 and the second avatar A2 (FIG. 9/STEP 302).

Specifically, the user environment determination unit 32 determines an image and a sound in the virtual space VS1 representing the environment of the first avatar A1 (including relative coordinates of the second avatar A2 and the like) as the environment to be recognized by the first user U1.

Next, the HMD 4 worn on the first user U1 outputs the determined environment (FIG. 9/STEP 303).

Specifically, the HMD 4 causes the monitor 40 mounted on the HMD 4 to display the determined image and causes the speaker 41 mounted on the HMD 4 to generate the determined sound.

Next, the user state recognition unit 33 of the server 3 judges whether the first user U1 or the second user U2 has performed some motion or not (FIG. 9/STEP 304).

Next, if the first user U1 or the second user U2 has performed some motion (in the case of YES at STEP 304), the flow returns to STEP 301, and the process at and after STEP 301 is executed again.

On the other hand, if the first user U1 or the second user U2 has not performed any motion (in the case of NO at STEP 304), the server 3 judges whether a signal indicating an instruction to end the process has been recognized or not (FIG. 9/STEP 305).

If the signal indicating the instruction to end the process has not been recognized (in the case of NO at STEP 305), the flow returns to STEP 304, and the process at and after STEP 304 is executed again.

On the other hand, if the signal indicating the instruction to end the process is recognized (in the case of YES at STEP 305), the system S ends this process.

By the above process, the first user U1 is caused to recognize that he exists in the virtual space VS as the avatar A1 as shown in FIG. 5. At this time, if the above-stated process at the time of causing the composite space to be experienced continues being executed for the second user U2, the second user U2 continues being in the state of experiencing the composite space MS. In the virtual space VS that is being experienced by the first user U1, however, the second avatar A2 corresponding to the second user U2 is in a state of performing a motion according to a motion of the second user U2.

### Other Embodiments

The embodiment shown in the drawings has been described above. The present invention, however, is not limited to such an embodiment.

For example, in the above embodiment, the description has been made on the case where the system S, which is an experience space switching system, is one computer system. The present invention, however, is not limited to a computer system and may be anything that is for executing the experience space switching method of the present invention.

Therefore, the present invention may be, for example, an experience space switching apparatus configured with one computer that comprises the processing units described in the above embodiment. Further, the present invention may be an experience space switching program for causing one or more arbitrary computers to execute the experience space switching method described before, and a recording medium in which the program is recorded and which is readable by a computer used by a user or the like.

### Reference Signs List

1 sign
2 camera
3 server (experience space switching system)
4 HMD (environment output device)
30 real space recognition unit
31 composite environment generation unit
31a virtual object generation unit
31b composite space generation unit
32 user environment determination unit
33 user state recognition unit (user motion recognition unit)
33a user posture recognition unit
33b user coordinates recognition unit
34 virtual object control unit
35 trigger event recognition unit
36 target user recognition unit (target person recognition unit)
37 virtual environment generation unit
37a avatar generation unit
37b virtual space generation unit
38 avatar state control unit
40 monitor
41 speaker
A avatar
A1 first avatar
A2 second avatar
MO model
MS composite space
RO1 table
RO2 bookshelf
RO3 drawer chest
RS real space
S system
U user
U1 first user (target person)
U2 second user (non-target person)
VO1 rock
VO2 rock wall
VO3 pillar
VS virtual space

1-9. (canceled)

10. An experience space switching method for switching space to be recognized by a user via an environment output device, the method being executed by a computer system, and the method comprising the steps of:
a real space recognition unit recognizing real space where the user exists;
a virtual object generation unit generating a virtual object to be recognized by the user;
a composite space generation unit generating composite space which is the real space with the virtual object existing therein;
a user environment determination unit determining an environment of the composite space to be recognized by the user via the environment output device;
a user motion recognition unit recognizing a motion of the user in the real space;
a trigger event recognition unit recognizing a predetermined trigger event which is a motion that the user performs to the virtual object;
a virtual space generation unit generating virtual space when the predetermined trigger event is recognized;
the user environment determination unit determining, instead of the environment of the composite space recognized by the user before the predetermined trigger event is recognized, an environment of the virtual space to be recognized by the user via the environment output device;
a target person recognition unit recognizing, from among a plurality of persons existing in the real space, the user who is a target person for whom switching of a type of space to be experienced is performed, and a non-target person for whom the switching of the type of the space to be experienced is not performed; and
an avatar generation unit generating a first avatar that performs a motion according to a motion of the user and a second avatar that performs a motion according to a motion of the non-target person, wherein
the environment of the virtual space to be recognized by the user includes the first avatar and the second avatar.

11. An experience space switching method for switching space to be recognized by a user via an environment output device, the method being executed by a computer system, and the method comprising the steps of:
a real space recognition unit recognizing real space where the user exists;
a virtual object generation unit generating a virtual object to be recognized by the user;
a composite space generation unit generating composite space which is the real space with the virtual object existing therein;
a user environment determination unit determining an environment of the composite space to be recognized by the user via the environment output device;
a user motion recognition unit recognizing a motion of the user in the real space;
a trigger event recognition unit recognizing a predetermined trigger event which is a motion that the user performs to the virtual object;
a virtual space generation unit generating virtual space when the predetermined trigger event is recognized; and
the user environment determination unit determining, instead of the environment of the composite space recognized by the user before the predetermined trigger event is recognized, an environment of the virtual space to be recognized by the user via the environment output device, wherein
a shape of the virtual space is generated according to a shape of the real space at a point of time when the trigger event is recognized.

12. An experience space switching method for switching space to be recognized by a user via an environment output device, the method being executed by a computer system, and the method comprising the steps of:
a real space recognition unit recognizing real space where the user exists;
a virtual object generation unit generating a virtual object to be recognized by the user;
a composite space generation unit generating composite space which is the real space with the virtual object existing therein;
a user environment determination unit determining an environment of the composite space to be recognized by the user via the environment output device;
a user motion recognition unit recognizing a motion of the user in the real space;
a trigger event recognition unit recognizing a predetermined trigger event which is a motion that the user performs to the virtual object;
a virtual space generation unit generating virtual space when the predetermined trigger event is recognized;
the user environment determination unit determining, instead of the environment of the composite space recognized by the user before the predetermined trigger event is recognized, an environment of the virtual space to be recognized by the user via the environment output device;
the virtual space generation unit generating space where the composite space and the virtual space are mixed; and
the user environment determination unit determining, after determining an environment of the space where the composite space and the virtual space are mixed, which is to be recognized by the user via the environment output device, instead of the environment of the composite space recognized by the user before the predetermined trigger event is recognized, the environment of the virtual space to be recognized by the user via the environment output device.

13. The experience space switching method according to claim 10, wherein
the virtual object has an attribute corresponding to an attribute of the virtual space generated when the predetermined trigger event is performed to the virtual object.

14. The experience space switching method according to claim 11, wherein
the virtual object has an attribute corresponding to an attribute of the virtual space generated when the predetermined trigger event is performed to the virtual object.

15. The experience space switching method according to claim 12, wherein
the virtual object has an attribute corresponding to an attribute of the virtual space generated when the predetermined trigger event is performed to the virtual object.

16. An experience space switching system, the experience space switching system being a computer system executing the experience space switching method according to claim 10.

17. An experience space switching system, the experience space switching system being a computer system executing the experience space switching method according to claim 11.

18. An experience space switching system, the experience space switching system being a computer system executing the experience space switching method according to claim 12.

19. An experience space switching apparatus, the experience space switching apparatus being a computer system executing the experience space switching method according to claim 10.

20. An experience space switching apparatus, the experience space switching apparatus being a computer system executing the experience space switching method according to claim 11.

21. An experience space switching apparatus, the experience space switching apparatus being a computer system executing the experience space switching method according to claim 12.

22. An experience space switching program, the experience space switching program causing a computer system to execute the experience space switching method according to according to claim 10.

23. An experience space switching program, the experience space switching program causing a computer system to execute the experience space switching method according to according to claim 11.

24. An experience space switching program, the experience space switching program causing a computer system to execute the experience space switching method according to according to claim 12.

25. A recording medium with the experience space switching program according to claim 22 being recorded therein, the experience space switching program being readable by a computer system.

26. A recording medium with the experience space switching program according to claim 23 being recorded therein, the experience space switching program being readable by a computer system.

27. A recording medium with the experience space switching program according to claim 24 being recorded therein, the experience space switching program being readable by a computer system.
